(19) United States
(12) Patent Application Publication
(10) Pub. No.: US 2020/0221497 A1
(43) Pub. Date: Jul. 9, 2020

(54) PROMOTING CHANNEL ACCESS FAIRNESS

(71) Applicant: Hewlett Packard Enterprise Development LP, Houston, TX (US)

(72) Inventors: Qiang ZHOU, Sunnyvale, CA (US); Shahnawaz SIRAJ, San Jose, CA (US); Andre BEAUDIN, Montreal (CA)

(21) Appl. No.: 16/647,774

(22) PCT Filed: Sep. 18, 2017
(86) PCT No.: PCT/CN2017/101998

§ 371 Date: Mar. 16, 2020

(51) Int. Cl. H04W 74/08; H04W 74/00; H04W 16/14

(52) U.S. Cl. CPC H04W 74/0808; H04W 84/12; H04W 16/14; H04W 74/006

(57) ABSTRACT

An example access point may include a first radio operating at a channel in a wireless local area network (WLAN); and a processor to detect a wireless transmission based on a different network protocol than a WLAN protocol on the channel, wherein the wireless transmission is received from a second radio; tune a set of Enhanced Distributed Channel Access (EDCA) values of the first radio in response to detecting the wireless transmission; apply a tuned set of EDCA values, to a beacon frame; transmit the beacon frame; and notify clients associated with the access point to update EDCA values with the tuned EDCA values to promote channel access fairness.

### BACKGROUND

A radio operating at a channel in a wireless local area network (WLAN) may experience unfair channel access when a different radio, based on a different network protocol other than a WLAN protocol, operates on the channel. The unfairness in channel access may result in an unfair balance towards communication from the different radio at the channel. Additionally, the different radio may not be aware of the radio operating at the channel.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a block diagram n example access point(AP), a second radio, and client devices;

FIG. 2 is a flowchart of an example method of promoting channel access fairness; and

FIG. 3 is a block diagram of a networking device capable of promoting channel access fairness.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

A radio operating at a channel in a wireless local area network (WLAN) may experience unfair channel access when a different radio, based on a different network protocol other than a WLAN protocol, operates on the channel. The unfairness in channel access may result in an unfair balance towards communication from the different radio at the channel. Additionally, the different radio may not be aware of the radio operating at the channel.

Examples described herein may utilize an access point (AP) including a processor capable of promoting channel access fairness. In such examples, the AP may detect other wireless transmissions from another radio that operates at the same channel. As noted above, these other wireless transmissions may be based on another protocol other than a WLAN protocol. To promote fairness in channel access, the processor of the AP may tune the Enhanced Distributed Channel Access (EDCA) values of the EDCA parameters for the packets sent by the AR The processor of the AP may apply the tuned EDCA values to a beacon frame. The processor of the AP may send the beacon frame, which contains the tuned EDCA values, to client devices (also known as clients, stations, or STAs) associated with the AR. In such examples, the processor of the AP may transmit the beacon frame at specified intervals. The processor may send the beacon frame with a notification. The notification may indicate a request that client devices associated with the AP update the client devices EDCA parameters for the packets sent by the client devices with the EDCA values included in the beacon frame. In such examples, the AP tunes the EDCA values to promote channel access fairness between the AP and the other radio on the channel that the AP and the other radio are operating at. The AP may tune EDCA values to various different values, based on various factors, which help to promote channel access fairness. The processor of the AP may update or tune other operating aspects of the AP to promote channel access fairness, such as increasing transmit power.

For example, an AP may include a first radio operating at a channel in a WLAN. The AP may also include a processor. The processor may detect a wireless transmission based on a different network protocol than a WLAN protocol on the channel. A second radio may send the wireless transmission. The processor may also tune a set of EDCA values of the EDCA parameters in the packets transmitted by the first radio, in response to detecting the wireless transmission. The processor may apply the tuned EDCA values to the EDCA parameters of a beacon frame. The processor may transmit the beacon frame. The processor may also notify the client devices associated with the AP to update the EDCA parameters for the packets sent by the client devices with the tuned EDCA values contained in the updated EDCA parameters of the beacon frame to promote channel access fairness.

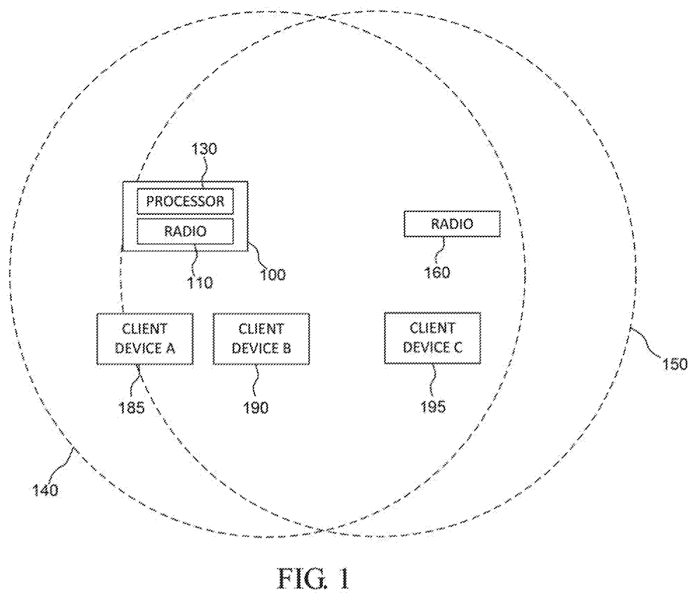

FIG. 1 is a block diagram of an example access point (AP) 100, a second radio 160, and client devices 185, 190, 195. The AP 100 may include a first radio 110 operating at a channel in a WLAN 140. The AP 100 may also include a processor 130. The processor 130 may detect a wireless transmission based on a different network protocol other than a WLAN protocol on the same channel that the AP 100 operates at. A second radio 160 may transmit the wireless transmission. The processor 130 may also tune a set of EDCA parameters in packets transmitted by of the first radio 110 of the AP 100, in response to the detection of the wireless transmission. The processor 130 may apply the tuned EDCA values to the EDCA parameters a beacon frame. The processor 130 may transmit the beacon frame. The processor 130 may also notify client devices, for example chant device A 185 and client device, B 190, associated with the AP 100 to update EDCA parameters for the packets transmitted by the client devices with the tuned EDCA values contained in the updated EDCA parameters of the beacon frame to promote channel access fairness.

As used herein, ‘access point’ (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

The AP 100 may include other components such as a machine-readable storage medium or memory. As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Any machine-readable storage medium described herein may be non-transitory.

As described above the AP may include a processor. As used herein, a “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

As described above, the AP may include a first radio. The first radio, and any additional radios of the AP may configure a set of EDCA parameters for the packets transmitted through the radios with various EDCA values. The AP may utilize an EDCA protocol to transmit these EDCA values to client devices. In some examples, the EDCA protocol can include a number of priority levels, such as access categories (ACs). For example, the ACs may include voice (VO), video (VI), best effort (BE), background (BK), and so on. The EDA values for a radio may include a minimum contention window (CWmin) and/or a maximum contention window (CWmax) that can be utilized to identify a range of values for a backoff timer. For example, the contention window can include a range of values to be selected for a backoff timer when there is a collision of data packets. A collision of data packets may occur when two or more client devices attempt to transmit a packet across a channel at the same time. Upon detecting a collision of data packets, the client devices can be assigned a backoff timer based on the contention window. In some examples, the backoff timer may be randomly selected. In this example, the client devices may wait for their respective backoff timers to end before attempting to retransmit the data packets. The EDCA parameters may also include an arbitration inter-frame spacing (AIFS). The AIFS may be utilized to prioritize one AC over another.

As described above, the AP may update the EDCA parameters of a beacon frame. In some examples, the beacon frame can be a wireless multimedia extension (WME) beacon frame and/or a Wi-Fi multimedia (WMM) beacon frame that notifies the client devices 185, 190 and/or other client devices associated with the access point 100 to update the EDCA values (e.g., contention window, etc.) in the packets transferred by the client devices. In some examples, probe responses can be utilized to update the EDCA values in the packets transmitted by the client devices 185, 190 and/or other client devices associated with the AP 100. For example, the tuned EDCA values can be programmed into the EDCA parameters of a WMM beacon frame and notify the client devices 185, 190 and/or other STAs that send a probe request to the AP 100.

As described above, the AP 100 may include a radio 110. The radio 110 may wirelessly send and/or receive data packets from other network devices. As used herein, ‘network device’ generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like. In some examples, the radio 110 can also be utilized to receive communication requests from a plurality of devices such as the client devices 185, 190.

In an example, the AP 100 may comply with the IEEE 802.11 wireless network protocol. In a further example, the second radio 160 may comply with an unlicensed Long Term Evolution (LTE) network protocol. In such examples, the AP 100 and the second radio 160 may operate in the same channel or band based on the network protocols that the AP 100 and second radio 160 use to communicate in the networks. As described above, this may cause packet collisions. In another example, the second radio 160 may be based on a listen before talk (LBT) or a duty-cycling set of rules. In another example, the second radio 160 supports client devices, such as client device C 195, in the second radio's 160 own network 150. The second radio 160 may operate at the same channel as the AP 100. Thus, channel access may be an issue when the WLAN 140 and the network 150 are operating at the same channel.

In an example, the processor 130 of the AP 100 may increase the transmission power of the AP 100 in response to the detection of the wireless transmission based on the different network protocol than the WLAN protocol on the channel. In such examples, the AP 100 may be based on an 802.11 network protocol. Further, the second radio 160 may be based on a different protocol, for example an unlicensed LTE network protocol. In such cases, the unlicensed LTE network protocol based second radio 160 may not be aware of the AP 100. Further, the unlicensed LTE network protocol based second radio 160 may not be aware of the AP 100 if the transmit power of the AP 100 is not high enough. In some cases, the transmit power of an 802.11 network protocol AP 100 may be low. An unlicensed LTE network protocol radio may recognize signals over a certain power, such as 62 decibel-milliwatts (DBM). In an example, the processor 130 may increase the transmit power of the AP 100 to the upper limit of a permitted value m response to the detection of the wireless transmission based on the unlicensed LTE network protocol on the channel. In such examples, an unlicensed LTE network protocol based radio may be able to recognize the AP.

In another example, the EDCA values of EDCA parameters in packets transmitted by the AP 100 may be aggressively tuned. In such examples, the processor 130 may significantly or aggressively lower the contention window of the EDCA values. Stated another way, the processor 130 may significantly or aggressively lower CWmin and CWmax. In a further example, the processor 130 may aggressively tune CWmin and CWmax for each AC. The processor 130 may adjust the CWmin and CWmax for each AC to a different value. In another example, the processor 130 may give higher than normal priority to the AIFS of the EDCA values for each AC.

As described above, the processor 130 may apply the tuned EDCA values to the EDCA parameters of a beacon frame. After the processor 130 tunes the set of EDCA values of EDCA parameters in packets transmitted by the AP 100, the processor 130 may apply the tuned EDCA values to the EDCA parameters of a beacon frame. In an example, the AP 100 may store a set of EDCA values for EDCA parameters in packets transmitted by the AP 100 and EDCA values for EDCA parameters in packets transmitted by client devices 185, 190 associated with the AP 100. The processor 130 may notify client devices 185, 190 associated with the AP 100 to update EDCA parameters for the packets transmitted by the client devices 185, 190 with the tuned EDCA values contained in the updated EDCA parameters of the beacon frame. The processor 130 may transmit the beacon frame to the client devices associated with the AP 100 at a specified time interval. The processor 130 may specify the time interval when the AP 100 is initialized or upon boot. The processor 130 may update the specified time interval at any time after boot. In another example, the processor 130 may transmit the beacon frame in response to the update of the EDCA parameters of the beacon frame.

In another example, the processor 130 may apply the tuned EDCA values to the EDCA parameters of a probe response. In a further example, a client device 185, 190 may send a probe request to the AP 100. In response to receiving the probe request, the processor 130 may send the probe response to the client device 185, 190 that sent the probe request. The probe responses EDCA parameters may contain the updated EDCA values. The client device 185, 190 may update the client devices 185, 190 EDCA parameters in the packets transmitted by the client devices 185, 190 using the EDCA parameters of the probe response.

As described above, the processor 130 may detect a wireless transmission on the channel that is based on a different network protocol. In an example, the processor 130 of the AP 100 may detect the wireless transmission through spectrum analysis. In such examples, the AP 100 may include spectrum analysis machine-readable instructions to be executed by the processor 130. When executed by the processor 130, the spectrum analysis machine-readable instructions may examine the channel in which the AP 100 is operating. Based on that examination, the AP 100 may recognize other client devices 195 or APs operating at the same channel. In another example, the AP 100 may also detect the wireless transmission through a third party packet analyzer or third party packet sniffer. The third party packet analyzer or third party packet sniffer may be a component separate from the AP 100. The third party packet analyzer or third part packet sniffer may analyze packets sent over a channel and determine other client devices 195 or AP's operating at the channel. In another example, the AP 100 may use other hardware or machine-readable instructions (such as software), which may be separate or a part of the AP 100, to detect wireless transmissions from other devices operating at the channel.

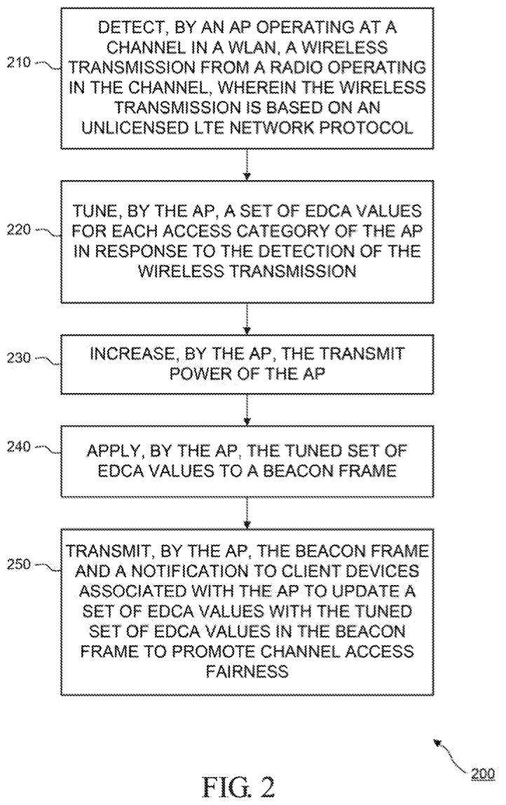

FIG. 2 is a flowchart of an example method 200 of promoting channel access fairness. In block 210, an AP operating at a channel in a WLAN may detect a wireless transmission from a radio operating in the channel. The wireless transmission may be based on an unlicensed LTE network protocol. As described above, the AP may detect the wireless transmission through spectrum analysis. In another example, the AP may detect the wireless transmission through the use of a third party packet analyzer. In another example, the AP may be based on an 802.11 network protocol.

In block 220, the AP may tune the EDCA values of EDCA parameters in packets transmitted by the AP for each AC of the AP in response to the detection of the wireless transmission described above. The AP may tune the EDCA values to promote channel access fairness. This is due to the fact that an unlicensed LTE based network may employ methods of channel access that are unfair in comparison to normal 802.11 methods. The unlicensed LTE based network may use a listen-before-talk rule, while the 802.11 network may utilize a random backoff time rule. The AP may set or tune the 802.11 AP's EDCA values to make the channel more accessible to WLAN as compared to the unlicensed LTE based network, to promote fair access of the channel between the two networks. In an example, the AP may have various AC's, such as VO, VI, BE, and BK, as described above. Each AC may have individual EDCA parameters for packets transmitted by the AR. In another example, each AC may have a CWmin, CWmax, and AIFS value. In another example, the AP may tune CWmin and CWmax to lower than normal (in other words, aggressively tune) values and AIFS to higher than normal (in other words, aggressively tune) priority to promote channel access fairness.

In bock 230, the AP may increase the transmit power of the AP, in response to the detection of the wireless transmission operating at the same channel. In an example, an unlicensed LTE network based radio may send the wireless transmission. The unlicensed LTE network based radio may not recognize an 802.11 based AP. As described above, this is due to the low transmit power utilized by the 802.11 based AP. In an example, AP may raise the transmit power of the AP to the maximum of the allowed transmit power. The unlicensed LTE network based radio may then recognize the 802.11 based AP, further promoting channel access fairness.

In block 240, the AP may apply the tuned EDCA values to EDCA parameters of a beacon frame. As described above, the client devices may utilize the updated EDCA parameters of the beacon frame to update the client devices EDCA values of EDCA parameters in packets transmitted by the client devices, the client devices being associated with the AP transmitting the beacon frame.

In block 250, the AP may transmit the beacon frame at the specified interval. In an example, the specified time interval may be the target beacon transmission time. In another example, the AP may adjust the specified time interval. The AP may adjust the specified time interval after the EDCA parameters of the beacon frame are tuned. The AP may set the specified time interval upon initialization of the AP. In another example, the AP may also transmit a notification to each of the APs client devices. The notification may request the client devices to update EDCA values with the aggressively tuned EDCA values to promote channel access fairness.

In a further example, the AP may apply the EDA values to the EDCA parameters of a probe response. Further, a client device may transmit a probe request on the channel to discover any AP's. The AP may apply the tuned EDCA values to the EDCA parameters of a probe response. The AP may receive the probe request. In response to the reception of the probe request, the AP may send the probes response to the requesting client device. The probe response may contain the tuned EDCA values in the EDCA parameters of the probe response and a notification. The notification may notify the receiving client device that the client device may update the EDCA parameters with the EDCA values contained in the EDCA parameters of the probe response.

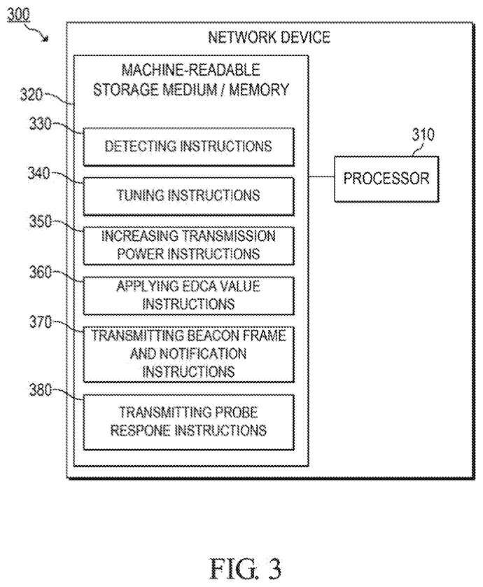

FIG. 3 is a block diagram of a network device 300 capable of promoting channel access fairness. A network device 300 such as an AP, may include a processor 310 and a machine-readable storage medium or 320. The machine-readable storage medium 320 may include instructions executable by the processor 310. The processor 310 may execute instructions 330 to detect wireless transmissions from another radio operating at the same channel as the network device 300. The wireless transmission may be based on another network protocol, other than a WLAN protocol. In another example, the wireless transmission may be based on an unlicensed LTE protocol. In another example, the instructions may include spectrum analysis instructions. In another example, the instructions may be separate from the network device. In another example, the instructions may include instructions for a third party packet analyzer, third party packet sniffer, or spectrum analyzer. In a further example, the third party packet analyzer, third party packet sniffer, or spectrum analyzer is a combination of machine-readable instructions and other electric components, which may be part of or separate from the network device 300.

The processor 310 may execute instructions 340 for tuning EDCA values of EDCA parameters in the packets transmitted by the network device 300. In another example, the instruction 340 may include instructions that, when executed by the processor 310, tune the EDCA values of the EDCA parameters in packets transmitted by the network device for each AC of the network device 300. The EDCA values of the EDCA parameters in packets transmitted by the network device for each AC may or may not be the same. The processor 310 may execute instruction 340 to tune the EDCA values of the EDCA parameters in packets transmitted by the network device in response to the detection of the wireless transmission described above. In another example, the instruction 340 may include instructions that, when executed by the processor 310, aggressively tune the EDCA values of the EDCA parameters in packets transmitted by the network device of the network device 300. The instruction 340 may include instructions that, when executed by the processor 310, may tune the EDCA values of the EDCA parameters in packets transmitted by the network device to smaller than normal values to promote fairness for channel access.

The processor 310 may execute instructions 350 for increasing the transmit power of the network device 300. In an example, the transmit power for the network device may have a maximum. Instructions 350, when executed by the processor 310, may increase the transmit power of the network device 300 to the maximum allowed transmit power. In another example, the instructions 350, when executed by the processor 310, may increase the transmit power to a value larger than the current transmit power of the network device 300, but lower than the maximum transmit power of the network device 300.

The processor 310 may execute instructions 360 for applying the tuned EDCA values to the EDCA parameters of a beacon frame. In response to the tuning of the EDCA values of the network device 300, the processor may execute the instructions 360 to apply the EDCA values to the EDCA parameters of a beacon frame. In another example, the instruction 360 may include instructions that, when executed by the processor 310, apply the tuned EDCA values to the EDCA parameters of a probe response. In such examples, the processor 310 may execute instruction 360 in response to the tuning of the EDCA values. In another example, the instruction 360 may include instructions that, when executed by the processor 310, apply the tuned EDCA values to the EDCA parameters of a probe response, in response to the reception of a probe request. In another example, if the EDCA values change at all then the processor 310 may execute the instruction 360 to apply the updated EDCA values to the EDCA parameters of the beacon frame and/or the probe response.

The processor 310 may execute instructions 370 for transmitting the beacon frame and notification. In an example, the processor 310 may execute the instructions 370 to transmit the beacon frame and notification at a specified interval. In another example, the processor 310 may set the specified interval may at initialization of the network device 300. In another example, the processor 310 may set the specified time interval at any point. In another example, the processor 310 may execute instructions 370 in response to a change of the EDCA values. In another example, the notification includes instructions for the client device receiving the beacon frame to update the client devices EDCA values to the EDCA values in the EDCA parameters of the beacon frame.

The processor 310 may execute instructions 380 for transmitting a probe response. As described above, the processor 310 may execute instructions 360 to apply updated EDCA values to a probe response. Also described above, the network device 300 may receive probe requests. In response to the reception of a probe request, the processor 310 may execute the instructions 380 to transmit the probe response to the client device sending the probe request.

Although the flow diagram of FIG. 2 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using, non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims.

1. An access point, comprising:
a first radio operating at a channel in a wireless local area network (WLAN);
a processor to:
detect a wireless transmission based on a different network protocol than a WLAN protocol on the channel, wherein the wireless transmission is received from a second radio;
tune a set of Enhanced Distributed Channel Access (EDCA) values of the first radio in response to detecting the wireless transmission;
apply a tuned set of EDCA values to a beacon frame;
transmit the beacon frame; and
notify client devices associated with the access point to update EDCA values with the tuned EDCA values to promote channel access fairness.

2. The access point of claim 1, wherein the processor tunes a transmission power of the first radio in response to detecting the wireless transmission based on the different network protocol than the WLAN protocol on the channel.

3. The access point of claim 1, wherein the processor transmits the beacon frame at a specified interval.

4. The access point of claim 1, wherein the different network protocol is an unlicensed Long-Term Evolution (LTE) network protocol.

5. The access point of claim 1, wherein the set of EDCA values are tuned to more aggressive values.

6. The access point of claim 5, wherein the processor lowers a contention window of the set of EDCA values.

7. The access point of claim 5, wherein the processor increases priority of an arbitration inter-frame spacing (AIFS) of the set of EDCA values.

8. The access point of claim 1, wherein the processor tunes the set of EDCA values for each of a set of access categories (ACs).

9. The access point of claim wherein the set of ACs correspond to a set of traffic types.

10. The access point of claim 1, wherein the processor detects the wireless transmission based on the different network protocol other than the WLAN protocol on the channel through spectrum analysis.

11. The access point of claim 1, wherein a third party packet analyze detects the wireless transmission based on the different network protocol than the WLAN protocol on the channel.

12. A method comprising:
detecting, by an access point (AP) operating at a channel in a wireless local area network (WLAN), a wireless transmission from a radio operating in the channel, wherein the wireless transmission is based on an unlicensed Long-Term Evolution (LTE) network protocol;
tuning, by the AP, a set of Enhanced Distributed Channel Access (EDCA) values for each access category of the AP in response to detection of the wireless transmission;
increasing, by the AP, a transmit power of the AP;
applying, by the AP, the tuned set of EDCA values to a beacon frame; and
transmitting, by the AP, the beacon frame and a notification to client devices associated with the AP to update a set of EDCA values with the aggressively tuned set of EDCA values in the beacon frame to promote channel access fairness.

13. The method of claim 12, further comprising:
applying, by the AP, the tuned set of EDCA values to a probe response; and
transmitting, by the AP, the probe response to a client device in response to a probe request from the client device.

14. A non-transitory machine-readable storage medium encoded with instructions executable by at least one processor of a network device, the machine-readable storage medium comprising instructions to:
detect a wireless transmission from a radio operating at a channel, wherein the network device operates at the channel and the wireless transmission is based on an unlicensed Long-Term Evolution network protocol;
tune a set of Enhanced Distributed Channel Access (EDCA) values for each access category of the network device in response to detection of the wireless transmission;
apply the tuned set of EDCA values to a beacon frame and a probe response in response to receiving a probe request;
transmit, at a specified interval, the beacon frame and a notification to client devices associated with the network device to update a set of EDCA values with the tuned set of EDCA values to promote channel access fairness; and
transmit the probe response.

15. The non-transitory machine-readable storage medium of claim 14, wherein the network device complies with the IEEE 802.11 wireless network protocol.
